(19) United States
(12) Patent Application Publication
(10) Pub. No.: US 2025/0328140 A1
(43) Pub. Date: Oct. 23, 2025

(54) MOTION CONTROL METHOD FOR ROBOT, ELECTRONIC DEVICE, AND COMPUTER-READABLE STORAGE MEDIUM

(71) Applicant: TENCENT TECHNOLOGY (SHENZHEN) COMPANY LIMITED, Shenzhen (CN)

(72) Inventors: Shuai WANG, Shenzhen (CN); Dongsheng ZHANG, Shenzhen (CN); Haitao WANG, Shenzhen (CN); Lingzhu XIANG, Shenzhen (CN); Qinqin ZHOU, Shenzhen (CN); Wanchao CHI, Shenzhen (CN); Ke CHEN, Shenzhen (CN); Shenghao ZHANG, Shenzhen (CN); Yu ZHENG, Shenzhen (CN); Xiong LI, Shenzhen (CN)

(21) Appl. No.: 19/254,602

(22) Filed: Jun. 30, 2025

Related U.S. Application Data
(63) Continuation of application No. PCT/CN2023/131830, filed on Nov. 15, 2023.

(30) Foreign Application Priority Data
May 29, 2023 (CN) 202310621872.9

(51) Int. Cl. G05D 1/24; B62D 57/02

(52) U.S. Cl. CPC G05D 1/24; B62D 57/022

(57) ABSTRACT

A motion control method for a robot includes obtaining environment information of a current environment of the robot and a current motion parameter of a joint of the robot; determining an environment type of the current environment; determining a current posture of the robot based on the current motion parameter of the joint; determining position information of the robot in the current environment; switching a current motion mode of the robot to a target motion mode corresponding to the environment type in response to the current posture and the position information satisfying a motion mode switching condition; and configuring a target motion parameter for the joint of the robot based on the target motion mode corresponding to the environment type, the target motion parameter being configured for switching a part of the robot in contact with a ground to a ground contact part in the target motion mode.

### CROSS-REFERENCES TO RELATED APPLICATIONS

This application is a continuation application of PCT Patent Application No. PCT/CN2023/131830, filed on Nov. 15, 2023, which claims priority to Chinese Patent Application No. 202310621872.9, filed on May 29, 2023, all of which is incorporated herein by reference in their entirety.

### FIELD OF THE TECHNOLOGY

The present disclosure relates to computer technologies, and in particular, to a motion control method for a robot, a motion control apparatus for a robot, an electronic device, and a computer-readable storage medium.

### BACKGROUND OF THE DISCLOSURE

With development of robot technologies, various robots have been increasingly widely used in fields including intelligent factories, intelligent logistics, and intelligent warehousing, which significantly improves automation degrees and reduces human resource costs. Common mobile robots include, for example, legged robot and wheeled robots.

To enable a robot to move flexibly and efficiently and adapt to a complex terrain environment, a wheeled-legged mobile robot is usually used. However, wheeled-legged mobile robots have a low traveling speed and poor stability, which limits their applications in human living environments.

The related art currently does not provide a desirable robot motion control manner with desirable environment adaptability.

### SUMMARY

One embodiment of the present disclosure provides a motion control method for a robot, the method being performed by an electronic device. The method includes obtaining environment information of a current environment, in which the robot is located, and a current motion parameter of a joint of the robot; determining an environment type of the current environment based on the environment information; determining a current posture of the robot based on the current motion parameter of the joint; determining position information of the robot in the current environment based on the environment information and the current motion parameter of the joint; switching a current motion mode of the robot to a target motion mode corresponding to the environment type in response to the current posture and the position information satisfying a motion mode switching condition; and configuring a target motion parameter for the joint of the robot based on the target motion mode corresponding to the environment type, the target motion parameter being configured for switching a part of the robot in contact with a ground to a ground contact part in the target motion mode.

Another embodiment of the present disclosure provides an electronic device. The electronic device includes one or more processors and a memory containing a computer program that, when being executed, causes the one or more processors to perform: obtaining environment information of a current environment, in which the robot is located, and a current motion parameter of a joint of the robot; determining an environment type of the current environment based on the environment information; determining a current posture of the robot based on the current motion parameter of the joint; determining position information of the robot in the current environment based on the environment information and the current motion parameter of the joint; switching a current motion mode of the robot to a target motion mode corresponding to the environment type in response to the current posture and the position information satisfying a motion mode switching condition; and configuring a target motion parameter for the joint of the robot based on the target motion mode corresponding to the environment type, the target motion parameter being configured for switching a part of the robot in contact with a ground to a ground contact part in the target motion mode.

Another embodiment of the present disclosure provides a non-transitory computer-readable storage medium containing a computer program that, when being executed, causes at least one processor to perform: obtaining environment information of a current environment, in which the robot is located, and a current motion parameter of a joint of the robot; determining an environment type of the current environment based on the environment information; determining a current posture of the robot based on the current motion parameter of the joint; determining position information of the robot in the current environment based on the environment information and the current motion parameter of the joint; switching a current motion mode of the robot to a target motion mode corresponding to the environment type in response to the current posture and the position information satisfying a motion mode switching condition; and configuring a target motion parameter for the joint of the robot based on the target motion mode corresponding to the environment type, the target motion parameter being configured for switching a part of the robot in contact with a ground to a ground contact part in the target motion mode.

### BRIEF DESCRIPTION OF THE DRAWINGS

FIG. 1 is a schematic diagram of an application mode of a motion control method for a robot according to an embodiment of the present disclosure.

FIG. 2 is a schematic structural diagram of an electronic device according to an embodiment of the present disclosure.

FIG. 3A to FIG. 3D are schematic flowcharts of a motion control method for a robot according to an embodiment of the present disclosure.

FIG. 4A to FIG. 4D are schematic structural diagrams of a robot according to an embodiment of the present disclosure.

FIG. 5A to FIG. 5B are schematic diagrams of robot motion according to an embodiment of the present disclosure.

FIG. 6A is a schematic diagram of a motion control method for a robot according to an embodiment of the present disclosure.

FIG. 6B is a schematic diagram of modules of a state controller according to an embodiment of the present disclosure.

FIG. 6C is a schematic diagram of modules according to an embodiment of the present disclosure.

### DESCRIPTION OF EMBODIMENTS

To make objectives, technical solutions, and advantages of the present disclosure clearer, the present disclosure is described below in further detail with reference to drawings. The described embodiments are not to be considered as a limitation on the present disclosure. All other embodiments obtained by a person of ordinary skill in the art without creative efforts fall within the protection scope of the present disclosure.

In the following description, a term “some embodiments” describes subsets of all possible embodiments, but “some embodiments” may be the same subset or different subsets of all of the possible embodiments, and may be combined with each other if no conflict exists.

In the following description, a term “first/second/third” is merely configured for distinguishing between similar objects and does not represent a specific order of objects. “First/second/third” may be transposed at a specific order or a sequence when allowed, so that the embodiments of the present disclosure described herein can be implemented in an order other than those illustrated or described herein.

Related data (such as environment information collected during robot operation and visual content in the environment information) collected and processed in the present disclosure, when applied in practical situations, needs to strictly comply with requirements of relevant national laws and regulations, and requires informed consent or individual consent of a personal information subject, and subsequent data use and processing behaviors need to be performed within the scope of authorization of laws and regulations and the personal information subject.

Unless otherwise defined, meanings of all technical and scientific terms used in this specification are the same as those usually understood by a person skilled in the art of the present disclosure. Terms used in this specification are merely intended to describe the embodiments of the present disclosure, and are not intended to limit the present disclosure.

Before the embodiments of the present disclosure are further described in detail, nouns and terms in the embodiments of the present disclosure are described, and the nouns and the terms in the embodiments of the present disclosure are applicable to the following explanations.

1). Mobile robot: It is, for example, a legged robot and a wheeled robot. To enable a robot to move flexibly and efficiently and adapt to a complex terrain environment, a wheeled-legged mobile robot is usually used. The wheeled-legged mobile robot is based on a legged robot. For example, a wheel is added to a bottom of a foot mechanism of the wheeled-legged mobile robot, so that the wheeled-legged mobile robot is agile in wheeled motion and flexible in legged motion, and can adapt to various complex terrains.

2). Multi-modal mobile robot: A motion mode of the multi-modal mobile robot may be switched between a legged mode and a wheeled mode. For example, the multi-modal mobile robot switches a two-wheel mode to a bipedal mode. Multi-modal in the name of the multi-modal mobile robot refers to a plurality of motion modes of the robot, and each motion mode is named after a limb supporting a motion. For example, the motion modes include a bipedal motion mode, a quadruped motion mode, a two-wheel motion mode, and a four-wheel motion mode.

3). Convolutional neural network (CNN): It is a feed forward neural network (FNN) including convolutional computation and having a deep structure, which is a representative algorithm of deep learning. The convolutional neural network has a representation learning capability, and can perform shift-invariant classification on input information based on a hierarchical structure thereof.

4). Inertial sensor (inertial measurement unit, IMU). It is an apparatus configured to measure posture angles (or angular rates) and accelerations of an object on three axes. The inertial sensor is mainly composed of three accelerometers, an acceleration sensor, three gyroscopes, and a resolution circuit. The accelerometers detect acceleration signals of an object on three independent axes of a coordinate system of a carrier, and the gyroscopes detect angular velocity signals of the carrier relative to a navigation coordinate system, to measure an angular velocity and an acceleration of the object in a three-dimensional space, and to calculate a posture of the object based on the angular velocity and the acceleration.

5). Distance sensor: It is also referred to as a displacement sensor, which is a sensor configured to sense a distance between the sensor and an object to complete a preset function. The distance sensor may be classified into various types such as an optical distance sensor, an infrared distance sensor, and an ultrasonic distance sensor based on different working principles of the distance sensor.

6). Tactile sensor: It is a sensor in a robot configured to imitate a tactile function. The tactile sensor may be classified into a touch sensor, a moment sensor, a pressure sensor, and a slide sensor.

The embodiments of the present disclosure provide a motion control method for a robot, a motion control apparatus for a robot, an electronic device, a computer-readable storage medium, and a computer program product, which can improve environment adaptability of the robot.

An exemplary application of the electronic device provided in the embodiments of the present disclosure is described below. The electronic device provided in the embodiments of the present disclosure may be implemented as various types of user terminals such as a notebook computer, a tablet computer, a desktop computer, a set-top box, a mobile device (for example, a mobile phone, a portable music player, a personal digital assistant, a dedicated messaging device, or a portable game device), an on-board terminal, a virtual reality (VR) device, or an augmented reality (AR) device, or may be implemented as a server. An exemplary application in which the device is implemented as a terminal device is described below.

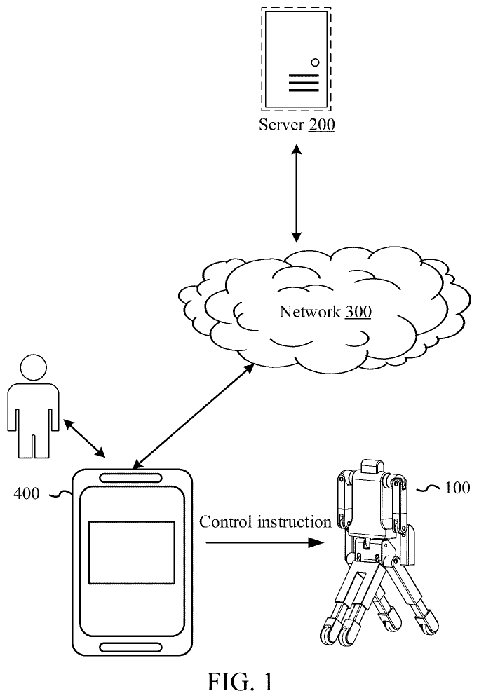

Referring to FIG. 1, FIG. 1 is a schematic diagram of an application mode of a motion control method for a robot according to an embodiment of the present disclosure. For example, FIG. 1 involves a server 200, a robot body 100, a network 300, and a terminal device 400. The terminal device 400 is connected to the server 200 through the network 300. The network 300 may be a wide area network, a local area network, or a combination thereof.

For example, a mechanical structure of the robot body 100 is controlled through the terminal device 400. The terminal device 400 invokes the motion control method for a robot provided in the embodiments of the present disclosure, to analyze environment information and motion parameters collected by a plurality of sensors arranged on the robot, determine a corresponding motion mode of the robot in a current environment, and control the robot to switch to the corresponding motion mode, so that the robot can move in a motion mode adapting to the current environment.

The embodiments of the present disclosure may be implemented through a database technology, which may be simply regarded as a place in an electronic filing cabinet where electronic files are stored. Users may add, query, update, or delete data in the files. The so-called “database” is data sets stored together in a specific manner to be shared by a plurality of users, which has as a minimized redundancy and is independent of an application program.

A database management system (DBMS) is a computer software system designed to manage databases, and generally has basic functions such as storage, interception, security, and backup. The DBMS may be classified based on database models the DBMS supports, for example, a relation or an extensible markup language (XML); or may be classified based on computer types the DBMS supports, for example, a server cluster or a mobile phone; or may be classified based on a query language used in the DBMS, for example, a structured query language (SQL) or XQuery; or may be classified based on key performance metrics, for example, a maximum scale or a highest running speed; or may be classified in other classification manners. Regardless of the classification manner that is used, some DBMSs can cover a plurality of categories, for example, support a plurality of query languages.

The embodiments of the present disclosure may alternatively be implemented through a cloud technology. The cloud technology is a collective name of a network technology, an information technology, an integration technology, a platform management technology, an application technology, and the like based on application of business models for cloud computing. The technologies may form a resource pool for use on demand, which is flexible and convenient. A cloud computing technology becomes an important support. Backend services of a technology network system require a lot of computing and storage resources, such as a video website, a picture website, and more portal websites. With rapid development and application of the Internet industry, and driving of needs such as a search service, a social network, mobile commerce, and open collaboration, each item may have an own hash encoding identification mark, which need to be transmitted to a background system for logical processing. Data of different levels is processed separately, and all kinds of industry data require support of a strong system, which can be achieved through only the cloud computing.

In some embodiments, the server may be an independent physical server, or may be a server cluster or a distributed system formed by a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform. The electronic device may be a smartphone, a tablet computer, a notebook computer, a desktop computer, a smart speaker, a smart watch, or the like, but is not limited thereto. The terminal device and the server may be directly or indirectly connected in a wired or wireless communication manner. This is not limited in the embodiments of the present invention.

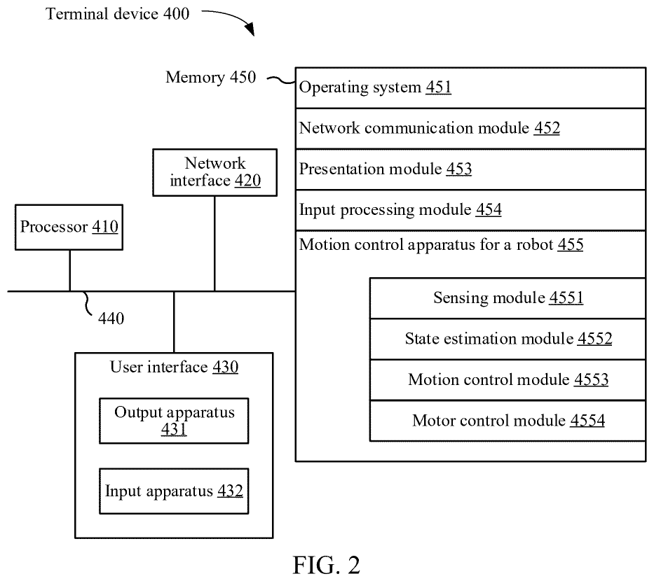

Referring to FIG. 2, FIG. 2 is a schematic structural diagram of an electronic device according to an embodiment of the present disclosure. The electronic device shown in FIG. 2 may be a terminal device, the terminal device 400 includes at least one processor 410, a memory 450, at least one network interface 420, and a user interface 430. Various components in the terminal device 400 are coupled together through a bus system 440. The bus system 440 is configured to implement connection and communication between the components. In addition to a data bus, the bus system 440 further includes a power bus, a control bus, and a status signal bus. However, for clarity, the buses are marked as the bus system 440 in FIG. 2.

The processor 410 may be an integrated circuit chip with a signal processing capability, for example, a general-purpose processor, a digital signal processor (DSP), another programmable logic device, a discrete gate, a transistor logic device, or a discrete hardware component. The general-purpose processor may be a microprocessor, any suitable processor, or the like.

The user interface 430 includes one or more output apparatuses 431 that enable presentation of media content, including one or more speakers and/or one or more visual displays. The user interface 430 further includes one or more input apparatuses 432, including user interface components that facilitate user input, such as a keyboard, a mouse, a microphone, a touch display, a camera, and another input button and control.

The memory 450 may be removable, non-removable, or a combination thereof. An exemplary hardware device includes a solid-state memory, a hard disk driver, an optical disk driver, and the like. In some embodiments, the memory 450 includes one or more storage devices physically away from the processor 410.

The memory 450 includes a volatile memory or a non-volatile memory, or may include both a volatile memory and a non-volatile memory. The non-volatile memory may be a read-only memory (ROM), and the volatile memory may be a random access memory (RAM). The memory 450 described in the embodiments of the present disclosure is intended to include any suitable type of memory.

In some embodiments, the memory 450 can store data to support various operations. Examples of the data include a program, a module, and a data structure, or a subset or a superset thereof. An exemplary description is provided below.

An operating system 451 includes system programs configured to process various basic system services and perform hardware-related tasks, for example, a frame layer, a core library layer, and a driver layer, which are configured to implement various basic services and process hardware-based tasks.

A network communication module 452 is configured to arrive at another electronic device through one or more (wired or wireless) network interfaces 420. Exemplary network interfaces 420 include Bluetooth, wireless fidelity (Wi-Fi), a universal serial bus (USB), and the like.

A presentation module 453 is configured to enable presentation of information through one or more output apparatuses 431 (for example, a display and a speaker) associated with the user interface 430 (for example, a user interface configured to operate a peripheral device and display content and information).

An input processing module 454 is configured to detect one or more user inputs or interactions from one of the one or more input apparatuses 432 and translate the detected inputs or interactions.

In some embodiments, an apparatus provided in the embodiments of the present disclosure may be implemented by software. FIG. 2 shows a motion control apparatus 455 for a robot stored in the memory 450. The motion control apparatus may be software in a form of a program and a plug-in, and includes the following software modules: a sensing module 4551, a state estimation module 4552, a motion control module 4553, and a motor control module 4554. These modules are logical, and therefore may be combined in different manners or further split based on functions to be implemented. Functions of the modules are described below.

The motion control method for a robot provided in the embodiments of the present disclosure is described in combination with exemplary applications and implementations of the electronic device provided in the embodiments of the present disclosure.

The motion control method for a robot provided in the embodiments of the present disclosure is described below. As described above, the electronic device implementing the motion control method for a robot provided in the embodiments of the present disclosure may be a terminal device, a server, or a combination thereof. Therefore, an execution subject of each operation is not described below.

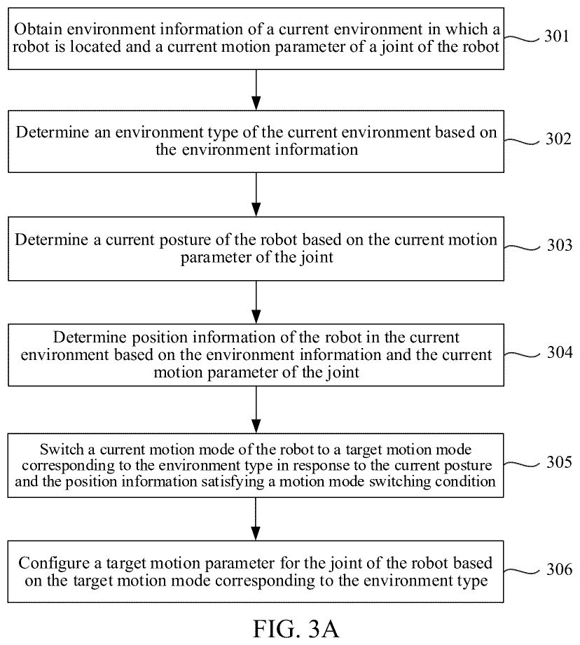

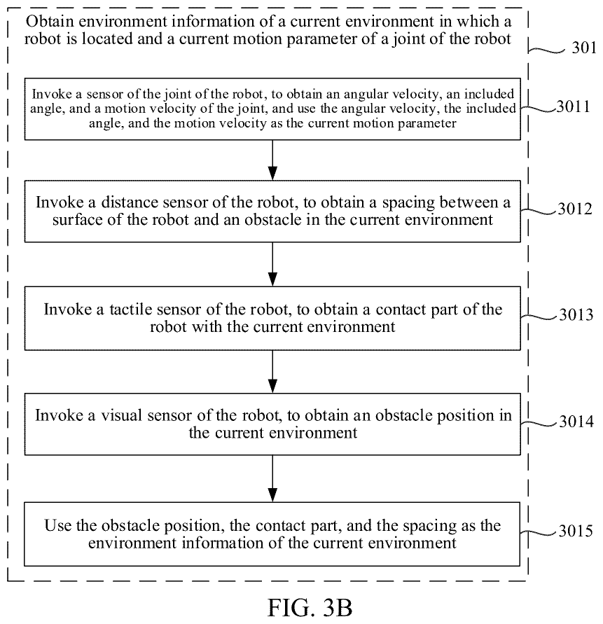

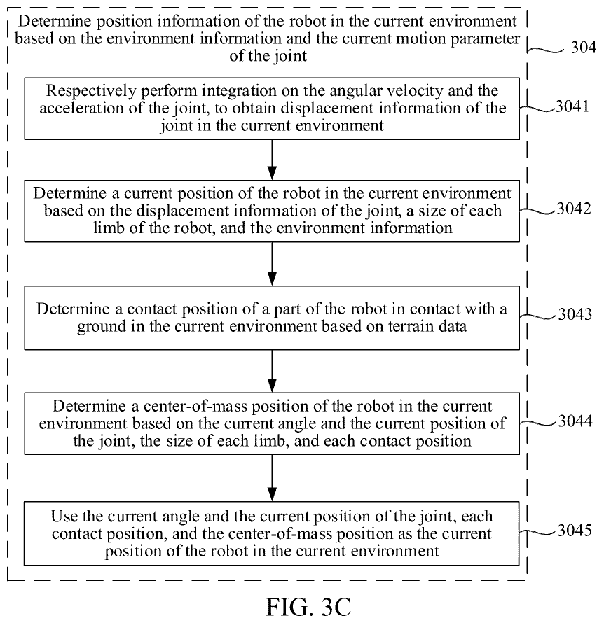

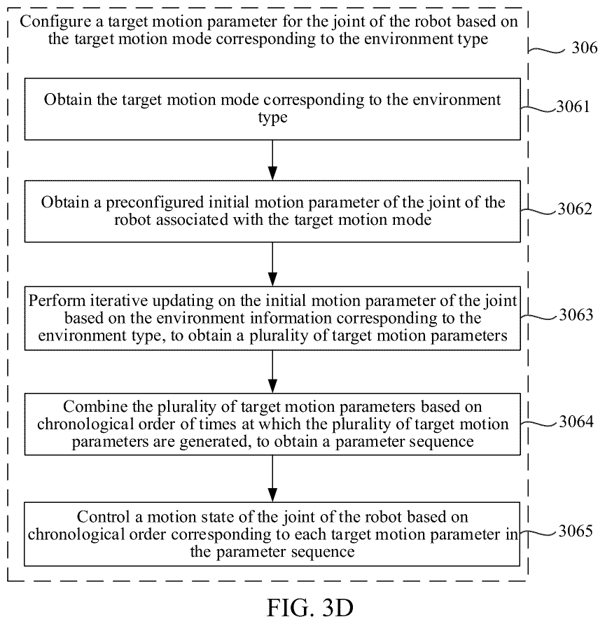

Referring to FIG. 3A, FIG. 3A is a schematic flowchart of a motion control method for a robot according to an embodiment of the present disclosure. A description is provided with reference to operations shown in FIG. 3A.

Operation 301: Obtain environment information of a current environment in which the robot is located and a current motion parameter of a joint of the robot.

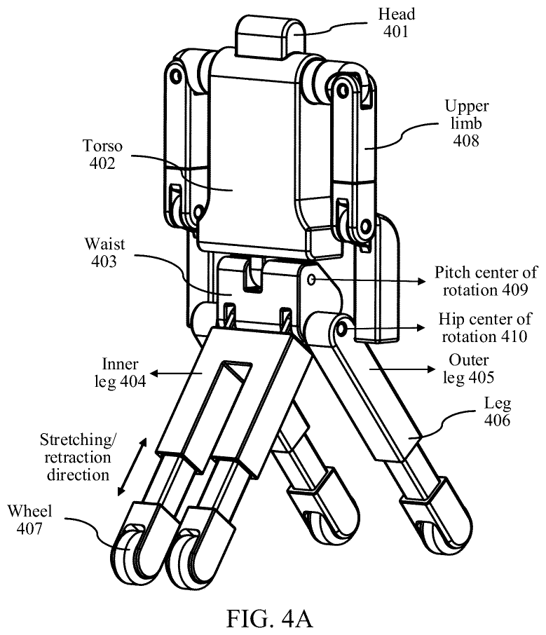

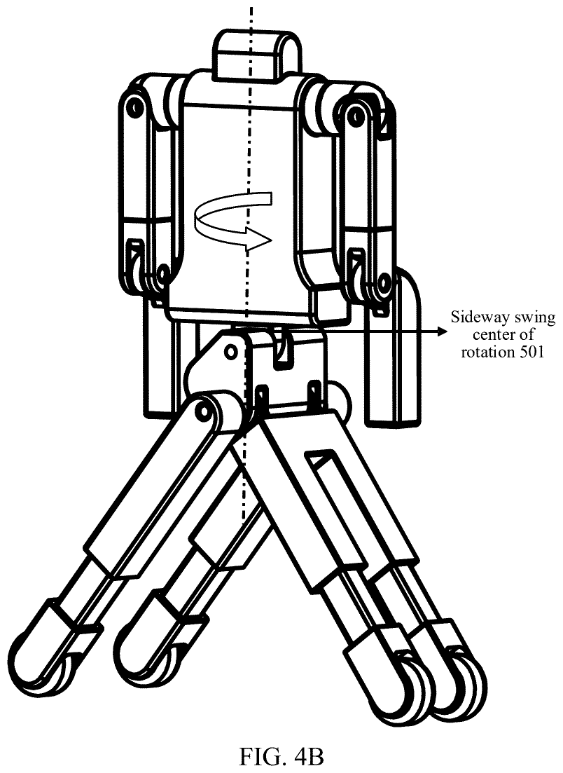

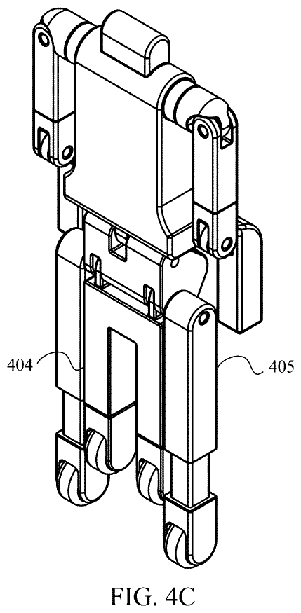

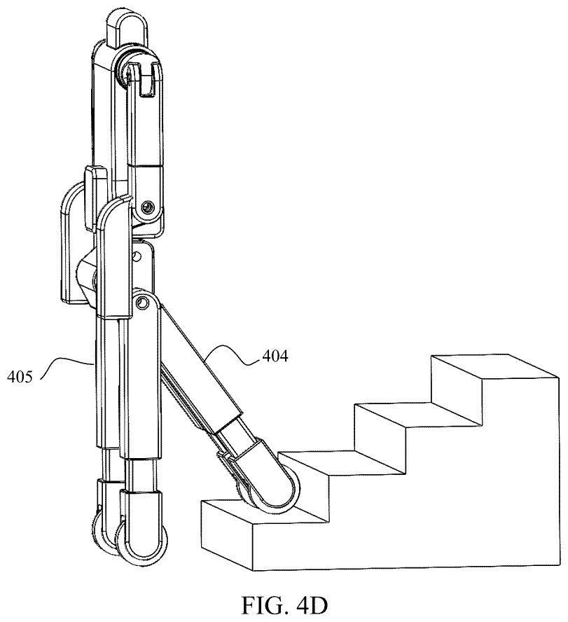

The robot in this embodiment of the present disclosure has different motion modes, and can switch between the different motion modes. For ease of explanation and description, a robot controlled by using the motion control method for a robot in this embodiment of the present disclosure is explained and described with reference to the drawings. Referring to FIG. 4A, FIG. 4A is a schematic structural diagram of a robot according to an embodiment of the present disclosure. The robot includes a head 401, a torso 402, a waist 403, a leg 406 (including an inner leg 404 and an outer leg 405), a wheel 407 at an end of each leg, an upper limb 408, a pitch center of rotation 409, and a hip center of rotation 410. In this embodiment of the present disclosure, a movement mode of the robot is mainly described. In other words, a motion of a part of the robot in contact with a ground is explained and described. The upper limb is not described in detail herein. Referring to FIG. 4B, FIG. 4B is a schematic structural diagram of a robot according to an embodiment of the present disclosure. The robot further includes a sideway swing center of rotation 501 configured to cause the torso of the robot to rotate about a direction perpendicular to the ground. The multi-modal mobile robot has a plurality of different types, and the motion control method for a robot provided in the embodiments of the present disclosure may be applied to different types of robots having a motion mode switching capability. The multi-modal mobile robot is not limited to the robot shown in FIG. 4A as an example.

For example, a motion parameter includes an angular velocity, an included angle, an acceleration, and a movement velocity of a motor joint of the robot. Operation 301 may be implemented by invoking a plurality of sensors arranged on the robot. The sensors arranged on the robot include a positioning (global positioning system, GPS) sensor, a tactile sensor of the leg, a force and moment sensor of the leg, an inertial sensor (inertia measurement unit, IMU), a distance sensor (time of flight, TOF), a remote control and an image processor (graphical user interface, GUI) responsible for human-computer interaction input, a camera, and a visual sensor, and the like.

In some embodiments, referring to FIG. 3B, FIG. 3B is a schematic flowchart of a motion control method for a robot according to an embodiment of the present disclosure. Operation 301 in FIG. 3A may implemented through operation 3011 to operation 3015 in FIG. 3B, which is described below in detail.

Operation 3011: Invoke a sensor of the joint of the robot, to obtain an angular velocity, an included angle, and a motion velocity of the joint, and use the angular velocity, the included angle, and the motion velocity as the current motion parameter.

For example, the sensor of the joint of the robot is an inertial sensor. The inertial sensor is configured to measure posture angles (or angular rates) and accelerations of an object on three axes. The inertial sensor arranged at the motor joint can obtain an angular velocity, an included angle, and a motion velocity of the motor joint.

Operation 3012: Invoke a distance sensor of the robot, to obtain a spacing between a surface of the robot and an obstacle in the current environment.

For example, the distance sensor may be classified into various types such as an optical distance sensor, an infrared distance sensor, and an ultrasonic distance sensor based on different working principles of the distance sensor. A specific type of the distance sensor arranged on the robot may be set based on a working scenario of the robot. This is not limited in this embodiment of the present disclosure. The distance sensor is arranged on an external surface of the robot, and can measure the spacing between the surface of the robot and the obstacle in the current environment.

Operation 3013: Invoke a tactile sensor of the robot, to obtain a contact part of the robot with the current environment.

For example, the tactile sensor is arranged on a part of the robot configured to contact the ground, and can obtain a posture and a motion mode of the robot based on the part of the robot currently in contact with the ground. The part of the robot in contact with the ground is a part of the robot configured to support a body for movement. A description is provided by using an example in which the part of the robot in contact with the ground is four feet. When the robot walks, the four feet are not always in contact with the ground, and instead, periodically or intermittently lift off the ground and contact the ground.

For another example, the robot is provided with four feet and four wheels. A tactile sensor is arranged at a corresponding position of each leg and each wheel. If the part of the robot in contact with the ground is the four feet in a preset time, the robot is in a quadruped motion mode.

Operation 3014: Invoke a visual sensor of the robot, to obtain an obstacle position in the current environment.

For example, the visual sensor may be a camera. A specific form of an obstacle near the robot or a specific form of a terrain may be determined by the camera arranged on the surface of the robot. The obstacle position in the current environment may be obtained through feature extraction on an image captured by the camera and in combination with the spacing obtained by the distance sensor.

Operation 3015: Use the obstacle position, the contact part, and the spacing as the environment information of the current environment.

In this embodiment of the present disclosure, the plurality of sensors are arranged on the robot, and the environment information around the robot and the motion parameter are determined in combination with data of the plurality of sensors, so that the obtained parameter is more comprehensive, thereby facilitating determining of the motion mode of the robot in the environment based on the environment information and the motion parameter.

In this embodiment of the present disclosure, the robot obtains comprehensive environment information through the plurality of sensors, so that the target motion mode and the target motion parameter that are obtained based on the environment information and the current motion parameter can be more adaptive to the environment, thereby improving motion stability of the robot in the environment, and enabling the robot to adapt to a plurality of different environments.

Still refer to FIG. 3A. Operation 302: Determine an environment type of the current environment based on the environment information.

For example, the environment type may be set based on an actual application scenario of the robot. This embodiment of the present disclosure is described by using an example in which the robot is applied to a life scenario of a user. Human life scenarios include environment types such as an upward staircase, a downward staircase, an upslope, a downslope, a smooth flat ground, and a rough flat ground. It is assumed that a ground environment is used as an obstacle. A terrain may be determined based on the spacing between the robot and the ground, and then a current environment type of the terrain may be determined as an upward staircase, a downward staircase, an upslope, a downslope, a smooth flat ground, or a rough flat ground based on the terrain.

Operation 303: Determine a current posture of the robot based on the current motion parameter of the joint.

In some embodiments, the motion parameter includes an included angle of the joint of the robot. Operation 303 in FIG. 3A may be implemented in the following manner: determining a relative position between each limb of the robot and a torso of the robot based on the included angle of the joint and the size of each limb of the robot; and determining a current posture of the robot based on the relative position between each limb and the torso of the robot.

For example, the relative position between each limb of the robot and the torso of the robot may be represented by a distance between a geometric center of the limb and a geometric center of the torso of the robot, or may be represented by the position relationship between the limb and the torso. For example, the relative position between the limb and the torso may be represented as the geometrical center of the limb being located on a lower left side of the body or the geometrical center of the limb being located on an upper right side of the torso.

Each posture corresponds to a different preconfigured range of the relative position between the limb and the torso of the robot. The preconfigured range to which a current relative position between the limb of the robot and the torso of the robot belongs is obtained, and a posture type corresponding to the preconfigured range is used as the current posture of the robot.

Operation 304: Determine position information of the robot in the current environment based on the environment information and the current motion parameter of the joint.

For example, the position information of the robot in the current environment includes a center-of-mass position, a joint position, and a contact position of the ground contact part of the robot in a coordinate system corresponding to the current environment.

In some embodiments, the motion parameter includes an acceleration and an angular velocity of the joint of the robot. The current motion parameter refers to a motion parameter at a current time. Referring to FIG. 3C, FIG. 3C is a schematic flowchart of a motion control method for a robot according to an embodiment of the present disclosure. Operation 304 in FIG. 3A may be implemented through operation 3041 to operation 3045 in FIG. 3C, which are described below in detail.

Operation 3041: Respectively perform integration on the angular velocity and the acceleration of the joint, to obtain displacement information of the joint in the current environment.

For example, integration is performed on the angular velocity over time, to obtain a joint angle change of the motor joint obtained, including an absolute value of the joint angle change and a joint angle change direction (decrease or increase). Integration is performed on the acceleration over time to obtain a displacement distance, the displacement distance including an absolute value of the displacement distance and a change direction of the displacement distance.

Operation 3042: Determine a current position of the robot in the current environment based on the displacement information of the joint, a size of each limb of the robot, and the environment information.

In some embodiments, the displacement information includes the joint angle change and the displacement distance, and the environment information includes terrain data. Operation 3042 may be implemented in the following manner: performing the following processing for the joint: updating an initial joint angle of the joint based on the joint angle change, to obtain a current angle of the joint, and updating an initial position of the joint based on the displacement distance, to obtain the current position of the joint.

For example, it is determined whether a current angle increases or decreases based on the joint angle change direction. The joint angle change direction includes a positive direction and a negative direction, the positive direction representing increase, and the negative direction representing decrease. For decrease, the absolute value of the joint angle change is subtracted from the initial joint angle, and for increase, the initial joint angle and the absolute value of the joint angle change are summed, to obtain the current angle. Similarly, the initial position is updated based on the displacement distance, to obtain the current position.

Operation 3043: Determine a contact position of the part of the robot in contact with the ground in the current environment based on the terrain data.

For example, position coordinates of the part of the robot in contact with the ground in the environment are determined based on the terrain data. Position coordinates of the robot in a coordinate system may be determined through the positioning sensor, and then contact position coordinates of the contact position of the part of the robot in contact with the ground in the current environment in the coordinate system corresponding to the environment are obtained in combination with a height of each position in the ground corresponding to the terrain data and a relative position between the part of the robot in contact with the ground and the positioning sensor of the robot.

Operation 3044: Determine a center-of-mass position of the robot in the current environment based on the current angle and the current position of the joint, the size of each limb, and each contact position.

For example, the current angle and the current position of the joint and each contact position are used as a column in a matrix, and are combined to form a rotation matrix configured for representing the position of the robot in the environment, to obtain a center-of-mass position of the torso of the robot in a coordinate system corresponding to the robot, and update the center-of-mass position in the coordinate system corresponding to the robot to a center-of-mass position in the coordinate system in the current environment based on the rotation matrix and the size of each limb of the robot.

Operation 3045: Use the current angle and the current position of the joint, each contact position, and the center-of-mass position as the current position of the robot in the current environment.

In this embodiment of the present disclosure, the position of the robot in the current environment is obtained based on a plurality of factors, so that the current position of the robot is represented more comprehensively, thereby facilitating motion mode switching based on the current position, and avoiding collision between the robot and an obstacle in a motion mode switching process.

Still refer to FIG. 3A. Operation 305: Switch a current motion mode of the robot to a target motion mode corresponding to the environment type in response to the current posture and the position information satisfying a motion mode switching condition.

For example, the robot includes at least two of the following motion modes: a four-wheel mode, a quadruped mode, a two-wheel mode, a two-wheel and bipedal mode, a bipedal mode, a fall recovery mode, and a folded mode. In other words, the robot in this embodiment of the present disclosure can switched between at least two motion modes. The motion modes are explained and described below.

In some embodiments, the current motion mode of the robot is switched to the fall recovery mode in response to the current posture being a falling posture and a distance between the current position of the robot and the obstacle being greater than a first distance threshold.

For example, when the part of the robot in contact with the ground includes at least part of the torso of the robot, it is determined that the robot is in a falling posture, and the distance sensor is invoked to obtain the distance between the external surface of the robot and the obstacle in the current environment. The first distance threshold may be a minimum distance at which the robot does not collide with the obstacle when recovering to a standing posture. The fall recovery mode refers to a mode in which the robot recovers to a standing or walking state from a falling state.

In some embodiments, a current battery capacity of the robot is obtained in response to the current posture being a motion posture and a distance between the current position of the robot and the obstacle being greater than a second distance threshold, and the current motion mode of the robot is switched to the folded mode in response to the current battery capacity being less than a battery capacity threshold.

For example, the folded mode is a motion mode in which a limb of the robot configured to contact the ground and the torso of the robot are folded together. The battery capacity threshold may be set to a minimum battery capacity supporting a motion of the robot. The second distance threshold may be a minimum distance at which the robot does not collide with the obstacle when switching to the folded mode.

In some embodiments, when the environment type is a flat ground, operation 305 is implemented in the following manner: switching the current motion mode of the robot to the four-wheel mode adapting to the flat ground in response to the current posture not being a four-wheel moving posture and the distance between the current position of the robot and the obstacle being greater than a third distance threshold.

For example, the four-wheel mode is a motion mode in which the part of the robot configured to contact the ground is four wheels, and the third distance threshold may be a minimum distance at which the robot does not collide with the obstacle when switching to the four-wheel mode. Referring to FIG. 4A, FIG. 4A is a schematic structural diagram of a robot according to an embodiment of the present disclosure. In FIG. 4A, the robot moves with the four wheels.

In some embodiments, when the environment type is a flat ground, operation 305 is implemented in the following manner: switching the current motion mode of the robot to the two-wheel mode adapting to the flat ground in response to the current posture not being a two-wheel moving posture and the distance between the current position of the robot and the obstacle being greater than the third distance threshold.

Referring to FIG. 4C, FIG. 4C is a schematic structural diagram of a robot according to an embodiment of the present disclosure. FIG. 4C shows a two-wheel mode. The two-wheel mode is a motion mode in which the part of the robot configured to contact the ground is two wheels, and the third distance threshold may be a minimum distance at which the robot does not collide with the obstacle when switching to the two-wheel mode.

In some embodiments, when the environment type is a non-flat ground, operation 305 is implemented in the following manner: switching the current motion mode of the robot to the quadruped mode adapting to the non-flat ground in response to the current posture not being a quadruped moving posture and the distance between the current position of the robot and the obstacle being greater than the third distance threshold.

For example, similar to the four-wheel mode, the quadruped mode is a motion mode in which the part of the robot configured to contact the ground is four feet, and the third distance threshold may be a minimum distance at which the robot does not collide with the obstacle when switching to the quadruped mode.

For example, a description is provided by using an example in which an application scenario of a robot is a human living environment, and the environment type of a non-flat ground may be a staircase ascending or descending environment. Referring to FIG. 4D, FIG. 4D is a schematic structural diagram of a robot according to an embodiment of the present disclosure. In FIG. 4D, the robot executes staircase ascending in a four-wheel mode. An inner leg 404 and an outer leg 405 of the robot move alternately. Motor joints of the inner leg 404 and the outer leg 405 correspondingly control limbs to change angles to cause the robot to move on the staircase, so that the motion of the robot adapts to a current staircase terrain.

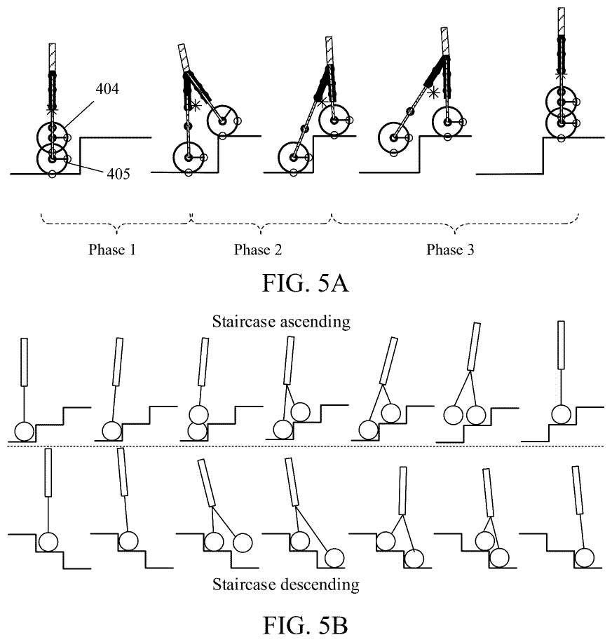

For ease of understanding the motion process of the robot, referring to FIG. 5A to FIG. 5B, FIG. 5A to FIG. 5B are schematic diagrams of robot motion according to an embodiment of the present disclosure. FIG. 5A and FIG. 5B are side views of the robot in FIG. 4D. In a phase 1 of FIG. 5A, the outer leg 405 of the robot is maintained in situ, and the inner leg 404 moves toward a higher step of the staircase. In a phase 2, the inner leg 404 is maintained at the higher step of the staircase, and the outer leg 405 moves toward the higher step of the staircase. In a phase 3, the outer leg 405 continues to move until the inner leg 404 and the outer leg 405 both reach a higher step. FIG. 5B shows a process in which the robot executes staircase ascending and descending based on the three-phase motion mode in FIG. 5.

Still refer to FIG. 3A. Operation 306: Configure a target motion parameter for the joint of the robot based on the target motion mode corresponding to the environment type.

For example, the target motion parameter is configured for switching the part of the robot in contact with the ground to a ground contact part in the target motion mode. The motion modes of the robot are described above. Taking the robot switching from the bipedal mode to the quadruped mode as an example, an acceleration and an angular velocity corresponding to a motor joint associated with each leg configured to contact the ground in the target motion mode (the quadruped mode) are obtained, the acceleration and the angular velocity corresponding to the motor joint are converted from digital signals into electrical signals, and the electrical signals are output to the corresponding motor joint, so that the motor joint of the robot executes related motions.

In some embodiments, referring to FIG. 3D, FIG. 3D is a schematic flowchart of a motion control method for a robot according to an embodiment of the present disclosure. Operation 306 in FIG. 3A is implemented through operation 3061 to operation 3065 in FIG. 3D, which is described below in detail.

Operation 3061: Obtain the target motion mode corresponding to the environment type.

For example, a researcher designing the robot preconfigures a corresponding target motion mode in each environment type. For example, a quadruped mode or a bipedal model may be configured for the environment type of staircase descending. When the robot is in a falling state, a fall recovery mode is configured.

In some embodiments, operation 3061 may be implemented in the following manner: invoking a neural network model to perform feature extraction based on the environment information corresponding to the environment type, to obtain an environment feature; invoking a classifier of the neural network model to determine a type of the environment feature, to obtain a motion mode corresponding to the environment feature; and using the motion mode corresponding to the environment feature as the target motion mode.

For example, a training sample set of the neural network model includes different environment information, actual environment types corresponding to the environment information, and motion modes corresponding to the actual environment types. An initialized neural network model is invoked based on the training sample set for training, so that the neural network model has a function of classifying environment information.

A training manner may be: obtaining a predicted classification result, determining a cross entropy loss of the neural network model based on a difference between the predicted classification result (a motion mode) and a motion mode corresponding to an actual environment type in a sample, executing back propagation on the neural network model based on the cross entropy loss, and performing gradient updating on a parameter of the neural network model, to obtain a trained neural network model.

Operation 3062: Obtain a preconfigured initial motion parameter of the joint of the robot associated with the target motion mode.

For example, a plurality of motion modes are provided. A description is provided by using a bipedal mode as an example. When the target motion mode of the robot is the bipedal mode, the preconfigured initial motion parameter of the bipedal mode is invoked, including parameters such as angular velocities and accelerations of motor joints associated with two feet used as the ground contact part in the bipedal mode of the robot.

Operation 3063: Perform iterative updating on the initial motion parameter of the joint based on the environment information corresponding to the environment type, to obtain a plurality of target motion parameters.

For example, the motion of the robot in the environment is affected by the environment. Therefore, an initial parameter such as an angular velocity and an acceleration of a motor joint is dynamically updated based on the environment information, to obtain an angular velocity and an acceleration of the robot at each time that adapted to the environment information, i.e., the plurality of target motion parameters.

Operation 3064: Combine the plurality of target motion parameters based on chronological order of times at which the plurality of target motion parameters are generated, to obtain a parameter sequence.

For example, each target motion parameter in the parameter sequence is configured for controlling a motion state of the joint at a different moment. The robot includes a plurality of motor joints, and different parameter sequences are provided for the joints.

Operation 3065: Control a motion state of the joint of the robot based on chronological order corresponding to each target motion parameter in the parameter sequence.

For example, the target motion parameter in the parameter sequence is converted from a digital signal into an electrical signal and is output to a joint of the robot, to control the joint to execute a corresponding motion state, so that the robot can adapt to the environment and move stably.

In this embodiment of the present disclosure, the environment information and the current posture of the robot are obtained, the target motion mode adapting to the current environment is determined, and the motion parameter of the robot is configured based on the parameter of the target motion mode, so that the motion mode of the robot is switched to the motion mode adapting to the environment, thereby improving environment adaptability of the robot, enabling stable motions of the robot in different environment types, and enabling the robot to adapt to different application scenarios.

Next, an exemplary application of the motion control method for a robot according to the embodiment of the present disclosure in an actual application scenario is described.

A bipedal mobile robot can travel in various complex terrains, nevertheless, has problems of a low traveling velocity and poor stability, which limits application of the bipedal mobile robot in an actual living environment. An embodiment of the present disclosure provides a motion control method for a robot, which is applicable to a robot with a plurality of motion modes. The method not only has an advantage of causing a legged robot to adapt to various terrains, but also can implement dynamic fast movement performance of the robot.

For example, the robot in this embodiment of the present disclosure includes a plurality of motion modes. Depending on a part of the robot configured to contact the ground, the motion modes of the robot include a two-wheel balance mode, a four-wheel and bipedal mode, a four-wheel mode, a four-wheel and quadruped mode, an X-wheel mode, a bipedal mode, a quadruped mode, a two-wheel and bipedal mode, an initial folded mode, and a fall recovery mode. These motion modes can implement movement in different environmental conditions. Modal switching methods include switching between two two-wheel balance modes (including a two-wheel balance mode based on an inverted pendulum model and a two-wheel balance mode based on whole-body dynamics control) and two four-wheel modes (including a four-wheel joint position control mode and a four-wheel joint force control-based whole body control (WBC) mode), switching between the two two-wheel balance modes and the X-wheel mode, switching between the initial folded mode and two four-wheel modes, switching between the two four-wheel modes and the two-wheel and bipedal mode, switching between a four-wheel mode and a two-wheel mode, switching between a two-wheel mode and the bipedal and two-wheel mode, and switching from the fall recovery mode to the other modes.

Each motion mode of the robot may be used as a modal, and the robot in the embodiments of the present disclosure is referred to as a multi-modal mobile robot below. The multi-modal mobile robot can perform modal switching based on different terrains. After entering a new environment, the robot determines environment information and performs corresponding modal switching by using a central control system, so that the robot can move in the new environment. The central control system includes an environment sensing module, a central control and data processing module, and an execution module. After using the modal switching method, the robot can implement rapid modal switching in different environments, to improve movement efficiency of the robot and reduce energy consumption of the robot. The robot has a mobile chassis, and further includes a waist and an upper limb. The upper limb is a single arm or double arms with an adjustable quantity of degrees of freedom. This embodiment of the present disclosure is not limited to the single arm or the double arms and to a specific quantity of the degrees of freedom of each arm.

For ease of explanation and description, a robot controlled by using the motion control method for a robot in this embodiment of the present disclosure is explained and described with reference to the drawings. Referring to FIG. 4A, FIG. 4A is a schematic structural diagram of a robot according to an embodiment of the present disclosure. The robot includes a head 401, a torso 402, a waist 403, a leg 406 (including an inner leg 404 and an outer leg 405), a wheel 407 at an end of each leg, an upper limb 408, a pitch center of rotation 409, and a hip center of rotation 410. In this embodiment of the present disclosure, a movement mode of the robot is mainly described. In other words, a motion of a part of the robot in contact with a ground is explained and described. The upper limb is not described in detail herein. Referring to FIG. 4B, FIG. 4B is a schematic structural diagram of a robot according to an embodiment of the present disclosure. The robot further includes a sideway swing center of rotation 501 configured to cause the torso of the robot to rotate about a direction perpendicular to the ground.

The motion control apparatus for a robot includes a sensing and input module, a state estimation module, a path planning module, a motion generation and control module, a motor low level control module, and a robot module.

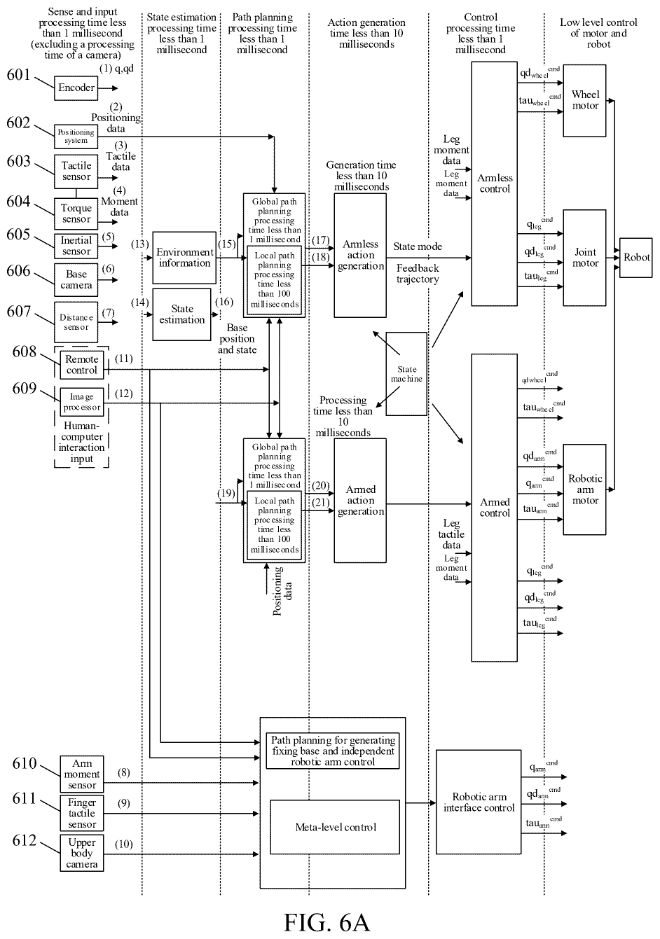

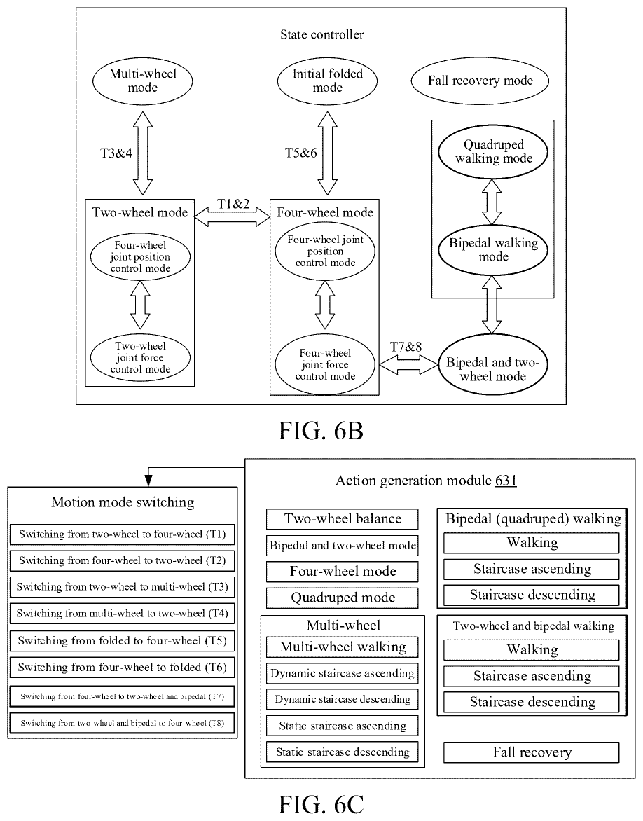

Referring to FIG. 6A, FIG. 6A is a schematic principle diagram of a motion control method for a robot according to an embodiment of the present disclosure. Sequence numbers marked in brackets in FIG. 6A represent different hardware output signals, and no chronological order exists between output of the hardware output signals. A processing time of the sensing and input module less than 1 millisecond (excluding a processing time of the camera). The hardware output signal in this portion includes a motor encoder 601 that can output angles q and joint angular velocities qd of all joints, a positioning (GPS) system 602, a tactile sensor 603 of the leg, a force and moment sensor 604 of the leg, an inertial sensor 605 (inertia measurement unit, IMU), a base camera 606, a distance sensor 607 (TOF), a remote controller 608 and an image processor 609 (GUI) that are responsible for human-computer interaction input, and the like. If control of a robotic arm of the robot is considered, an arm moment sensor 610 of the robotic arm, a finger tactile sensor 611 of a finger end, and an upper body camera 612 of an upper body are further needed.

A signal of each sensor in the sensing and input module is output to a state estimation module. A processing time of the state estimation module is less than 1 millisecond. The module is configured to identify an environment, and can identify whether the ground is flat and whether an obstacle exists in surroundings on the ground. The position information and posture information of a robot base may be further obtained through state estimation. The position and the posture may be in a world coordinate system, or may be in a body coordinate system of the robot.

A processing time of the path planning module is less than 1 millisecond, and the module is configured for global path planning (having a processing time less than 1 s) and local path planning (having a processing time less than 100 milliseconds). Depending on whether control is introduced to the robotic arm during the motion of the robot chassis, the global and local path planning is divided into two parts, namely, not adding a robotic arm and adding a robotic arm.

A processing time of the motion generation module is less than 10 milliseconds. The motion generation module is divided into two modules, i.e., an action generation module without a robotic arm and an action generation module with a robotic arm. Referring to FIG. 6C, FIG. 6C is a schematic diagram of modules according to an embodiment of the present disclosure. An action generation module 631 is configured to control action generation of switching actions (T1 to T8) between the two modules, and also includes action generation in a single mode such as the two-wheel balance mode, the four-wheel and bipedal mode, the four-wheel mode, and the four-wheel and quadruped mode. In the X-wheel mode, the action generation module includes action generation of X-wheel walking, static staircase ascending, static staircase descending, dynamic staircase ascending, and dynamic staircase descending. Action generation of the bipedal (quadruped) mode includes action generation of a bipedal (quadruped) walking mode, a bipedal (quadruped) staircase ascending mode, and a bipedal (quadruped) staircase descending mode. Action generation of the two-wheel and bipedal mode includes action generation of two-wheel and bipedal walking, two-wheel and bipedal staircase ascending, and two-wheel and bipedal staircase descending. In addition, the action generation module 631 is further configured to control action generation of fall recovery in different scenarios.

Based on characteristics of the robot, types of the motor in the embodiments of the present disclosure include a wheel motor, a leg/waist motor, and a robotic arm motor. These motors respectively control a position, a velocity, or a moment input of a joint angle. All control signals required by the motor are calculated by the motion generation module, and the posture control of the robot can be implemented by transmitting the control signals of the motion generation module to the motor.

FIG. 6B is a schematic diagram of modules of a state controller according to an embodiment of the present disclosure. The state controller is configured to control a multi-wheel mode, an initial folded mode, and a fall recovery mode. A two-wheel balance mode (2-wheel mode) is specifically classified into a two-wheel balance (2-wheel) mode based on a wheel-inverted pendulum (WIP) model and a two-wheel balance (2-wheel) mode based on WBC. Switching between the two modes is allowed.

A four-wheel and bipedal mode (4-wheel+bipedal mode) allows walking on a flat ground and staircase ascending and descending.

A four-wheel traveling mode (4-wheel mode) includes moving operations such as moving forward, moving backward, turning, and rotating in situ, and is specifically classified into a four-wheel joint position control mode (4-wheel driving) (position control of upper body joint positions other than the wheels) and a four-wheel joint force control-based WBC mode (4-wheel WBC). Switching between the two modes is allowed. Referring to FIG. 4C, FIG. 4C is a schematic structural diagram of a robot according to an embodiment of the present disclosure. Referring to FIG. 4D, FIG. 4D is a schematic structural diagram of a robot according to an embodiment of the present disclosure. FIG. 4C shows a two-wheel mode, and in FIG. 4D, the robot executes staircase ascending in a four-wheel mode.

The X-wheel mode is described as follows: Because during staircase ascending, both the two-wheel balance mode and the four-wheel traveling mode exist, before which switching from the two-wheel balance mode to the four-wheel traveling mode, switching from the four-wheel traveling mode to the two-wheel balance mode, and switching from one two-wheel balance mode to the other two-wheel balance mode (switching between left wheels and right wheels) exist, and a final objective of arrangements and combinations of these modes is to make the center of mass of the robot meet a requirement of the staircase ascending and descending task and make an end of a wheel-leg steps within a specified footprints range, arrangements and combinations of the suitable actions are listed separately and named as an X-wheel mode (a multi-wheel mode).

An initial folded mode is a mode in which turn-on and turn-off configurations are in a folded form, and is a folded form. Processing such as a joint position self-check is completed in this posture.

The two-wheel and bipedal mode (2-wheel+bipedal mode) allows walking on the flat ground and staircase ascending and descending.

The bipedal and bipedal mode (bipedal walking mode) allows walking on the flat ground and staircase ascending and descending.

In the quadruped mode (quadruped walking mode) in this embodiment of the present disclosure, each leg has no rotation degree in a rotation direction, and the legs on the left and the right are asymmetric during walking. Three legs may perform stance on the ground to adjust the center of mass and the posture in a front-rear direction, and one leg lifts, so that the robot can walk on the flat ground and execute staircase ascending and descending. The four-wheel and quadruped mode (wheel+quadruped mode) allows walking on the flat ground and staircase ascending and descending.

The fall recovery mode is initiated to prevent the robot from damaging humans, to ensure that the environment is not damaged while ensuring that humans around the robot are not injured, and to ensure that software and hardware systems of the robot are not damaged while ensuring that humans are not injured and the environment is not damaged. Switching between the two two-wheel balance modes and the two four-wheel modes is allowed, which may be represented by T1&T2. Switching between the two two-wheel balance modes and the X-wheel mode is allowed, which may be represented by T3&T4. Switching between the initial folded mode and the two four-wheel modes is allowed, which may be represented by T5&T6. Switching between the two four-wheel modes and the two-wheel and bipedal mode is allowed, which may be represented by T7&T8. Switching between the four-wheel mode and the two-wheel mode is allowed. Switching between the two-wheel mode and the bipedal and two-wheel mode is also allowed. The fall recovery mode may be enabled by any other module when some conditions sensed by the sensor of the robot satisfy some characteristics, in other words, when the robot has a fall risk or already falls down, and a recovery policy is initiated.

For meanings of signals corresponding to the English in FIG. 6A, Reference may be made to Table (1).

| English | Meaning |
|---|---|
| cmd_vel | Time sequence of forward-moving and turning |
| | velocity instructions of a robot |
| footPrints[ ] | Time sequence of motion footprints |
| | of the robot |
| ComTraj[ ] | Time sequence of center-of-mass motion trajectories |
| | of the robot |
| IMU (base | Posture angle and a posture angular velocity of a |
| orientation/twist) | robot base tested by the IMU |
| IMU offset | Difference between an IMU output and a true value |
| q (Jnt pos) | All joint angles (including six floating base positions |
| | and postures in a generalized coordinate system) of |
| | the robot |
| qd (Jnt vel) | All joint angular velocities (including six floating |
| | base velocities and rotation angular velocities in a |
| | generalized coordinate system) of the robot |
| FT sensors | Six-dimensional force and moment sensor |
| Tactile sensors | Tactile sensor |
| q_{leg}^{ref}[ ] | Time sequence of leg joint motor angle reference |
| | values |
| qd_{leg}^{ref}[ ] | Time sequence of leg joint motor angular velocity |
| | reference values |
| tau_{leg}^{ref}[ ] | Time sequence of leg joint motor moment reference |
| | values |
| qₐᵣₘ^{ref}[ ] | Time sequence of robotic arm joint motor angle |
| | reference values |
| qdₐᵣₘ^{ref}[ ] | Time sequence of robotic arm joint motor angular |
| | velocity reference values |
| tauₐᵣₘ^{ref}[ ] | Time sequence of robotic arm joint motor moment |
| | reference values |
| q_{wheel}^{ref}[ ] | Time sequence of wheel joint motor angle reference |
| | values |
| qd_{wheel}^{ref}[ ] | Time sequence of wheel joint motor angular velocity |
| | reference values |
| tau_{wheel}^{ref}[ ] | Time sequence of wheel joint motor moment reference |
| | values |
| q_{leg}^{cmd}[ ] | Time sequence of leg joint motor angle instruction |
| | values |
| qd_{leg}^{cmd}[ ] | Time sequence of leg joint motor angular velocity |
| | instruction values |
| tau_{leg}^{cmd}[ ] | Time sequence of leg joint motor moment instruction |
| | values |
| qₐᵣₘ^{cmd}[ ] | Time sequence of robotic arm joint motor angle |
| | instruction values |
| qdₐᵣₘ^{cmd}[ ] | Time sequence of robotic arm joint motor angular |
| | velocity instruction values |
| tauₐᵣₘ^{cmd}[ ] | Time sequence of robotic arm joint motor moment |
| | instruction values |
| q_{wheel}^{cmd}[ ] | Time sequence of wheel joint motor angle instruction |
| | values |
| qd_{wheel}^{cmd}[ ] | Time sequence of wheel joint motor angular velocity |
| | instruction values |
| tau_{wheel}^{cmd}[ ] | Time sequence of wheel joint motor moment |
| | instruction values |

A signal that can be obtained by each specific module of a sensing and input portion and related format information are provided in the detailed description of the information flow in FIG. 6A. The motor encoder provides values of the angle and the angular velocity of the joint motor of the robot. The values of the angle and the angular velocity of the joint motor may define an overall configuration of the robot, for example, a change of an upper body posture angle of the robot in the two-wheel balance state, a length of each leg, and specific angles of included angles between the legs and degrees of freedom, such as pitch and yaw, of an upper body waist joint of the robot in the four-wheel state. A specific movement direction and movement distance of the center of mass of the robot relative to the initial point may be calculated through integration based on a leg and wheel odometer. The positioning sensor can provide relatively accurate global positioning information.

The inertial sensor (IMU) may obtain information such as a displacement and a posture of the robot in a space through integration on the acceleration and the angular velocity.

The distance sensor (TOF) may obtain a distance between a point on the surface of the robot and the obstacle, to avoid the obstacle, and may further use a relative position and a specific change relative to an unchanging object in the environment for positioning.

The camera and another visual module are configured to detect and recognize an object in the environment, to lay a foundation for actions such as image construction and obstacle avoidance, and further implement positioning thereof based on information such as RGB and depth.

For example, output data of the leg and wheel odometer, the GPS, the IMU, the TOF, the camera, and the another visual module is combined, and the combined data is input to the neural network model. Position and posture estimation of the robot may be implemented through the neural network model.

In some embodiments, Kalman filtering, extended Kalman filtering, particle filtering, and the like may be performed on the output data of the sensing module. Under the foregoing algorithm architecture, a confidence probability of data of a signal source or some signal sources is adjusted through adjustment of values at corresponding positions in different parameter matrices, so as to obtain a relatively accurate result.

Data and true values (ground truth) of a plurality of data sources in different operating conditions of the robot, different environments, and different scenarios, where the true values may come from collection of captured motion data, to train and determine a parameter in the neural network, thereby implementing effective fusion of data of the plurality of data sources in different operating conditions of the robot, different environments, and different scenarios. In some embodiments, an initial value may be provided by using a signal source preset based on experience, and is then iteratively updated by using data of other signal sources. In this way, a compromise between operation efficiency and state estimation result precision may be formed to some extent.

Cameras installed on a lower body and an upper body of the robot actually provide a relative position relationship between the robot and the external environment through visual sensing. However, the camera on the upper body may further provide relatively accurate local positions, posture feedback, and environment information when a robotic arm and a gripper execute an operation task, bringing convenience for completing the operation task based on the design of the upper body.

The force and moment sensor (F/T sensor) may obtain a magnitude of a force or a moment on a joint or a position on which the sensor is installed, so as to learn the contact and interaction situations of the robot in the environment. A common operation is to introduce an error or relative magnitude of the force into a control closed-loop, to calculate a control instruction of the motor at a next time, thereby implementing soft control of the joint of the robot and a smooth closed-loop interaction with the environment. The tactile sensor functions similarly to the force and moment sensor (F/T sensor) to some extent, except that the tactile sensor can provide more accurate and richer signals. The tactile sensor is generally in a form of a sensor array. The sensor can feed back a touch condition and a magnitude of a touch force of each point. According to the embodiment of the present disclosure, a position of the robot in contact with an external force, a shape of the object with which the robot is in contact, and distribution information of the force can be predicted. A tactile sensor applied to a sole of the foot can obtain a more precise quantity of contact points between the robot and the ground surface, and accurately switch model information configured for control of the robot based on whole body dynamics model, and phase information configured for planning. A tactile sensor applied to a finger and a palm can more precisely sense a shape, a state, and force-bearing information of an object touched by a hand, thereby completing an operation, even an in-hand manipulation task. Specific use principles of force and moment sensors (F/T sensor) and tactile sensors installed on the upper body and the lower body are the same as the above, which are not described in detail herein.

In some embodiments, in a scenario in which the robot needs to be charged or placed in a folded manner when a motion begins or ends, the sensing system needs to fuse data streams to determine whether an obstacle exists around the robot and determine a specific distance of an obstacle from the robot and the like. When it is determined that the surroundings and a state of the robot both satisfy a state switching condition, the robot is switched to the initial folded mode. For example, the switching condition is that the distance between the obstacle and the robot does not cause the robot to collide with the obstacle during motion mode switching and that the robot is in a non-folded mode.

When the robot needs to recover to a normal motion state sequence when falling accidentally to ensure safety of the robot, the environment, and a user, the sensing system needs to fuse data streams to determine whether an obstacle exists around the robot and determine a specific distance of an obstacle from the robot and the like. When it is determined that the surroundings and a state of the robot both satisfy a state switching condition, the robot needs to be switched to the fall recovery mode. For example, the switching condition is that the distance between the obstacle and the robot does not cause the robot to collide with the obstacle during motion mode switching.

In a scenario in which a ground is relatively flat and the robot is required to move relatively fast and is required to consume relatively low energy for running, the sensing system needs to fuse data streams to determine whether an obstacle exists around the robot and determine a specific distance of an obstacle from the robot and the like. When it is determined that the surroundings and a state of the robot both satisfy a state switching condition, the robot is preferentially switched to the four-wheel mode. For example, the switching condition is that the distance between the obstacle and the robot does not cause the robot to collide with the obstacle during motion mode switching and that the robot is in a non-four-wheel mode.

In a scenario in which a ground is relatively flat and the robot is required to move relatively fast, is required to consume relatively low energy for running, is required to occupy a relatively small area, or is required to have high motion agility, the sensing system needs to fuse data streams to determine whether an obstacle exists around the robot and determine a specific distance of an obstacle from the robot and the like. When it is determined that the surroundings and a state of the robot both satisfy a state switching condition, the robot is preferentially switched to the two-wheel mode. For example, the switching condition is that the distance between the obstacle and the robot does not cause the robot to collide with the obstacle during motion mode switching and that the robot is in a non-two-wheel mode.

In a scenario in which a ground is relatively complex, the robot is not required to move fast, no requirement is imposed on energy consumption of the robot for running, but relatively high anti-interference performance and high stability are required, the sensing system needs to fuse data streams to determine whether an obstacle exists around the robot and determine a specific distance of an obstacle from the robot and the like. When it is determined that the surroundings and a state of the robot both satisfy a state switching condition, the robot is preferentially switched to the quadruped mode. For example, the switching condition is that the distance between the obstacle and the robot does not cause the robot to collide with the obstacle during motion mode switching, that the robot is in a non-quadruped mode, and that a probability of falling during switching is less than a preset probability.

In a scenario in which a ground is relatively complex, the robot is not required to move fast, no requirement is imposed on energy consumption of the robot for running, and the robot is required to occupy a relatively small area, or is required to have high motion agility, the sensing system needs to fuse data streams to determine whether an obstacle exists around the robot and determine a specific distance of an obstacle from the robot and the like. When it is determined that the surroundings and a state of the robot both satisfy a state switching condition, the robot is preferentially switched to the quadruped mode. For example, the switching condition is that the distance between the obstacle and the robot does not cause the robot to collide with the obstacle during motion mode switching, that the robot is in a non-quadruped mode, and that a probability of falling during switching is less than a preset probability.

During staircase ascending, the sensing system needs to fuse data streams to determine whether an obstacle exists around the robot and determine a specific distance of an obstacle from the robot and the like. When it is determined that the surroundings and a state of the robot both satisfy a state switching condition, the robot is preferentially switched to the X-wheel mode or the two-wheel and bipedal mode. The robot may selectively be switched to the four-wheel and bipedal mode, the four-wheel and quadruped mode, or the two-wheel and bipedal mode in combination with a motion characteristic and an application scenario of the robot.

In some embodiments, for path planning, a path that is relatively short, on which the robot requires relatively low energy consumption, and that has relatively high execution stability is preferentially selected.

For example, if the robot is currently in the four-wheel state, the robot can still reach the target point when a staircase as well as a flat ground and a slope exist in front. If the two paths do not differ greatly, the robot preferentially selects the path with the flat ground and the slope more suitable for the wheel mode and not requiring the motion mode of the robot to be switched. If the robot is currently in the two-wheel balance state, the robot can still reach the target point when a staircase as well as a flat ground and a slope exist in front. However, a distance for walking on the staircase is far less than a distance for walking on the flat ground and the slope. Therefore, the robot preferentially selects the staircase ascending mode to which the robot can be more easily switched, rather than selecting the longer path with the flat ground and the slope.

In this embodiment of the present disclosure, the environment information and the current posture of the robot are obtained, the target motion mode adapting to the current environment is determined, and the motion parameter of the robot is configured based on the parameter of the target motion mode, so that the motion mode of the robot is switched to the motion mode adapting to the environment, thereby improving environment adaptability of the robot, enabling stable motions of the robot in different environment types, and enabling the robot to adapt to different application scenarios. In different motion modes, through the action trajectory generation method, and in combination with a corresponding control policy, difficulty in motions of the robot in a complex environment is reduced, and the environment adaptability of the robot is improved.

An exemplary structure of the motion control apparatus 455 for a robot provided in the embodiments of the present disclosure implemented as a software module is further described below. In some embodiments, as shown in FIG. 2, software modules stored in the motion control apparatus 455 for a robot of the memory 450 may include: a sensing module 4551, configured to obtain environment information of a current environment in which the robot is located and a current motion parameter of a joint of the robot; a state estimation module 4552, configured to determine an environment type of the current environment based on the environment information, the state estimation module 4552 being configured to determine a current posture of the robot based on the current motion parameter of the joint; and the state estimation module 4552 being configured to determine position information of the robot in the current environment based on the environment information and the current motion parameter of the joint; a motion control module 4553, configured to switch a current motion mode of the robot to a target motion mode corresponding to the environment type in response to the current posture and the position information satisfying a motion mode switching condition; and a motor control module 4554, configured to configure a target motion parameter for the joint of the robot based on the target motion mode corresponding to the environment type, the target motion parameter being configured for switching a part of the robot in contact with a ground to a ground contact part in the target motion mode.

In some embodiments, the current motion parameter includes an acceleration and an angular velocity of the joint of the robot. The state estimation module 4552 is configured to: respectively performing integration on the angular velocity and the acceleration of the joint, to obtain displacement information of the joint in the current environment; and determine a current position of the robot in the current environment based on the displacement information of the joint, a size of each limb of the robot, and the environment information.

In some embodiments, the displacement information includes a joint angle change and a displacement distance, and the environment information includes terrain data. The state estimation module 4552 is configured to perform the following processing for the joint: updating an initial joint angle of the joint based on the joint angle change, to obtain a current angle of the joint, and updating an initial position of the joint based on the displacement distance, to obtain the current position of the joint; determining a contact position of the part of the robot in contact with the ground in the current environment based on the terrain data; determining a center-of-mass position of the robot in the current environment based on the current angle and the current position of the joint, the size of each limb, and each contact position; and using the current angle and the current position of the joint, each contact position, and the center-of-mass position as the current position of the robot in the current environment.

In some embodiments, the current motion parameter includes an included angle of the joint of the robot. The state estimation module 4552 is configured to: determine a relative position between each limb of the robot and a torso of the robot based on the included angle of the joint and the size of each limb of the robot; and; determine a current posture of the robot based on the relative position between each limb and the torso of the robot.

In some embodiments, the motor control module 4554 is configured to: obtain the target motion mode corresponding to the environment type; obtain a preconfigured initial motion parameter of the joint of the robot associated with the target motion mode; perform iterative updating on the initial motion parameter of the joint based on the environment information corresponding to the environment type, to obtain a plurality of target motion parameters; combine the plurality of target motion parameters based on chronological order of times at which the plurality of target motion parameters are generated, to obtain a parameter sequence, each target motion parameter in the parameter sequence being configured for controlling a motion state of the joint at a different time; and control a motion state of the joint of the robot based on chronological order corresponding to each target motion parameter in the parameter sequence.

In some embodiments, the motor control module 4554 is configured to: invoke a neural network model to perform feature extraction based on the environment information corresponding to the environment type, to obtain an environment feature; invoke a classifier of the neural network model to determine a type of the environment feature, to obtain a motion mode corresponding to the environment feature; and use the motion mode corresponding to the environment feature as the target motion mode.

In some embodiments, the sensing module 4551 is configured to: invoke a sensor of the joint of the robot, to obtain an angular velocity, an included angle, and a motion velocity of the joint, and using the angular velocity, the included angle, and the motion velocity as the current motion parameter; invoke a distance sensor of the robot, to obtain a spacing between a surface of the robot and an obstacle in a current environment; invoke a tactile sensor of the robot, to obtain a contact part of the robot with the current environment; invoke a visual sensor of the robot, to obtain an obstacle position in the current environment; and use the obstacle position, the contact part, and the spacing as the environment information of the current environment.

In some embodiments, the robot includes at least two of the following motion modes: a four-wheel mode, a quadruped mode, a two-wheel mode, a two-wheel and bipedal mode, a bipedal mode, a fall recovery mode, and a folded mode.

In some embodiments, the motion control module 4553 is configured to switch the current motion mode of the robot to the fall recovery mode in response to the current posture being a falling posture and a distance between the current position of the robot and the obstacle being greater than a first distance threshold.

In some embodiments, the motion control module 4553 is configured to obtain a current battery capacity of the robot in response to the current posture being a motion posture and a distance between the current position of the robot and the obstacle being greater than a second distance threshold, and switch the current motion mode of the robot to the folded mode in response to the current battery capacity being less than a battery capacity threshold.

In some embodiments, the motion control module 4553 is configured to switch, when the environment type is a flat ground, the current motion mode of the robot to the four-wheel mode adapting to the flat ground in response to the current posture not being a four-wheel moving posture and the distance between the current position of the robot and the obstacle being greater than a third distance threshold.

In some embodiments, the motion control module 4553 is configured to switch, when the environment type is a flat ground, switch the current motion mode of the robot to the two-wheel mode adapting to the flat ground in response to the current posture not being a two-wheel moving posture and the distance between the current position of the robot and the obstacle being greater than the third distance threshold.

In some embodiments, when the environment type is a non-flat ground, the motion control module 4553 is configured to switch the current motion mode of the robot to the quadruped mode adapting to the non-flat ground in response to the current posture not being a quadruped moving posture and the distance between the current position of the robot and the obstacle being greater than the third distance threshold.

An embodiment of the present disclosure provides a computer program product, the computer program product including a computer program or computer-executable instructions, the computer program or the computer-executable instructions being stored in a computer-readable storage medium. A processor of an electronic device reads the computer-executable instructions from the computer-readable storage medium, and the processor executes the computer-executable instructions, so that the electronic device performs the motion control method for a robot provided in the embodiments of the present disclosure.

An embodiment of the present disclosure provides a computer-readable storage medium having computer-executable instructions and a computer program stored therein, the computer-executable instructions or the computer program, when executed by a processor, causing the processor to perform the motion control method for a robot provided in the embodiments of the present disclosure, for example, the motion control method for a robot shown in FIG. 3A.

In some embodiments, the computer-readable storage medium may be a memory such as a ferroelectric random access memory random access memory (FRAM), a ROM, a programmable read-only memory (PROM), an erasable programmable read-only memory (EPROM), an electrically erasable programmable read-only memory (EEPROM), a flash memory, a magnetic surface memory, a compact disc, or a compact disc read-only memory (CD-ROM), or may be various devices including one or any combination of the foregoing memories.

In some embodiments, the computer-executable instructions may be compiled in any form of programming language (including a compiling or interpretive language, or a declarative or procedural language) in a form of a program, software, a software module, a script, or code, and may be deployed in any form, for example, deployed as a standalone program or as a module, a component, a subroutine, or other units suitable for use in a computing environment.

In an example, the computer-executable instruction may but unnecessarily correspond to a file in a file system, and may be stored in a part of a file having other programs or data stored therein, for example, stored in one or more scripts in a hypertext markup language (HTML) document, stored in a single file dedicated for a discussed program, or stored in a plurality of collaborative files (for example, files having one or more modules, subprograms, or code parts stored therein).

For example, the executable instructions may be deployed to be executed on one electronic device, or on a plurality of electronic devices at one location, or on a plurality of electronic devices distributed at a plurality of locations and connected through a communication network.

Based on the above, in the embodiments of the present disclosure, the environment information and the current motion parameter of the current posture of the robot are obtained, the target motion mode adapting to the current environment is determined, and the current motion parameter of the robot is configured as the target motion parameter adapting to the target motion mode based on the parameter of the target motion mode, so that the motion mode of the robot is switched to the motion mode adapting to the environment, thereby improving environment adaptability of the robot, enabling stable motions of the robot in different types of environments, enabling the robot to adapt to different application scenarios, and improving versatility of the robot.

As used herein, the term module (and other similar terms such as submodule, unit, subunit, etc.) in the present disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing descriptions are only an example of the present disclosure and are not intended to limit the protection scope of the present disclosure. Any modification, equivalent replacement, or improvement made within the spirit and principle of the present disclosure falls within the protection scope of the present disclosure.

What is claimed is:

1. A motion control method for a robot, performed by an electronic device, the method comprising:
obtaining environment information of a current environment, in which the robot is located, and a current motion parameter of a joint of the robot;
determining an environment type of the current environment based on the environment information;
determining a current posture of the robot based on the current motion parameter of the joint;
determining position information of the robot in the current environment based on the environment information and the current motion parameter of the joint;
switching a current motion mode of the robot to a target motion mode corresponding to the environment type in response to the current posture and the position information satisfying a motion mode switching condition; and
configuring a target motion parameter for the joint of the robot based on the target motion mode corresponding to the environment type, the target motion parameter being configured for switching a part of the robot in contact with a ground to a ground contact part in the target motion mode.

2. The method according to claim 1, wherein the current motion parameter comprises an acceleration and an angular velocity of the joint of the robot; and
determining the position information of the robot in the current environment comprises:
respectively performing integration on the angular velocity and the acceleration of the joint, to obtain displacement information of the joint in the current environment; and
determining a current position of the robot in the current environment based on the displacement information of the joint, sizes of limbs of the robot, and the environment information.

3. The method according to claim 2, wherein the displacement information comprises a joint angle change and a displacement distance, and the environment information comprises terrain data; and
determining the current position of the robot in the current environment based on the displacement information of the joint, sizes of the limbs of the robot, and the environment information comprises:
performing following processing for the joint: updating an initial joint angle of the joint based on the joint angle change, to obtain a current angle of the joint, and updating an initial position of the joint based on the displacement distance, to obtain the current position of the joint;
determining a contact position of the part of the robot in contact with the ground in the current environment based on the terrain data;
determining a center-of-mass position of the robot in the current environment based on the current angle and the current position of the joint, the sizes of limbs, and contact positions; and
using the current angle and the current position of the joint, contact positions, and the center-of-mass position as the current position of the robot in the current environment.

4. The method according to claim 1, wherein the current motion parameter comprises an included angle of the joint of the robot; and
determining the current posture of the robot based on the current motion parameter of the joint comprises:
determining a relative position between a limb of the robot and a torso of the robot based on the included angle of the joint and sizes of limbs of the robot; and
determining a current posture of the robot based on the relative position between the limb and the torso of the robot.

5. The method according to claim 1, wherein configuring the target motion parameter for the joint of the robot based on the target motion mode corresponding to the environment type comprises:
obtaining the target motion mode corresponding to the environment type;
obtaining a preconfigured initial motion parameter of the joint of the robot associated with the target motion mode;
performing iterative updating on the initial motion parameter of the joint based on the environment information corresponding to the environment type, to obtain a plurality of target motion parameters;
combining the plurality of target motion parameters based on chronological order of times at which the plurality of target motion parameters are generated, to obtain a parameter sequence, a target motion parameter in the parameter sequence being configured for controlling a motion state of the joint at a different time; and
controlling a motion state of the joint of the robot based on chronological order corresponding to the target motion parameter in the parameter sequence.

6. The method according to claim 5, wherein obtaining the target motion mode corresponding to the environment type comprises:
invoking a neural network model to perform feature extraction based on the environment information corresponding to the environment type, to obtain an environment feature;
invoking a classifier of the neural network model to determine a type of the environment feature, to obtain a motion mode corresponding to the environment feature; and
using the motion mode corresponding to the environment feature as the target motion mode.

7. The method according to claim 1, wherein obtaining the environment information of the current environment, in which the robot is located, and the current motion parameter of the joint of the robot comprises:
invoking a sensor of the joint of the robot, to obtain an angular velocity, an included angle, and a motion velocity of the joint, and using the angular velocity, the included angle, and the motion velocity as the current motion parameter;
invoking a distance sensor of the robot, to obtain a spacing between a surface of the robot and an obstacle in the current environment;
invoking a tactile sensor of the robot, to obtain a contact part of the robot with the current environment;
invoking a visual sensor of the robot, to obtain an obstacle position in the current environment; and
using the obstacle position, the contact part, and the spacing as the environment information of the current environment.

8. The method according to claim 7, wherein the robot comprises at least two of following motion modes: a four-wheel mode, a quadruped mode, a two-wheel mode, a two-wheel and bipedal mode, a bipedal mode, a fall recovery mode, and a folded mode.

9. The method according to claim 8, further comprising:
switching the current motion mode of the robot to the fall recovery mode in response to the current posture being a falling posture and a distance between the current position of the robot and the obstacle being greater than a first distance threshold.

10. The method according to claim 9, further comprising:
obtaining a current battery capacity of the robot in response to the current posture being a motion posture and a distance between the current position of the robot and the obstacle being greater than a second distance threshold, and
switching the current motion mode of the robot to the folded mode in response to the current battery capacity being less than a battery capacity threshold.

11. The method according to claim 1, wherein
when the environment type is a flat ground, switching the current motion mode of the robot to a target motion mode corresponding to the environment type in response to the current posture and the position information satisfying the motion mode switching condition comprises:
switching the current motion mode of the robot to a four-wheel mode adapting to the flat ground in response to the current posture not being a four-wheel moving posture and the distance between the current position of the robot and the obstacle being greater than a third distance threshold.

12. The method according to claim 11, wherein when the environment type is a flat ground, switching the current motion mode of the robot to the target motion mode corresponding to the environment type in response to the current posture and the position information satisfying the motion mode switching condition comprises:
switching the current motion mode of the robot to a two-wheel mode adapting to the flat ground in response to the current posture not being a two-wheel moving posture and the distance between the current position of the robot and the obstacle being greater than the third distance threshold.

13. The method according to claim 11, wherein when the environment type is a non-flat ground, switching the current motion mode of the robot to the target motion mode corresponding to the environment type in response to the current posture and the position information satisfying the motion mode switching condition comprises:
switching the current motion mode of the robot to a quadruped mode adapting to the non-flat ground in response to the current posture not being a quadruped moving posture and the distance between the current position of the robot and the obstacle being greater than the third distance threshold.

14. An electronic device, comprising:
one or more processors and a memory containing a computer program that, when being executed, causes the one or more processors to perform:
obtaining environment information of a current environment, in which the robot is located, and a current motion parameter of a joint of the robot;
determining an environment type of the current environment based on the environment information;
determining a current posture of the robot based on the current motion parameter of the joint;
determining position information of the robot in the current environment based on the environment information and the current motion parameter of the joint;
switching a current motion mode of the robot to a target motion mode corresponding to the environment type in response to the current posture and the position information satisfying a motion mode switching condition; and
configuring a target motion parameter for the joint of the robot based on the target motion mode corresponding to the environment type, the target motion parameter being configured for switching a part of the robot in contact with a ground to a ground contact part in the target motion mode.

15. The device according to claim 14, wherein the current motion parameter comprises an acceleration and an angular velocity of the joint of the robot; and the one or more processors are further configured to perform:
respectively performing integration on the angular velocity and the acceleration of the joint, to obtain displacement information of the joint in the current environment; and
determining a current position of the robot in the current environment based on the displacement information of the joint, sizes of limbs of the robot, and the environment information.

16. The device according to claim 15, wherein the displacement information comprises a joint angle change and a displacement distance, and the environment information comprises terrain data; and the one or more processors are further configured to perform:
performing following processing for the joint: updating an initial joint angle of the joint based on the joint angle change, to obtain a current angle of the joint, and updating an initial position of the joint based on the displacement distance, to obtain the current position of the joint;
determining a contact position of the part of the robot in contact with the ground in the current environment based on the terrain data;
determining a center-of-mass position of the robot in the current environment based on the current angle and the current position of the joint, the sizes of limbs, and contact positions; and
using the current angle and the current position of the joint, contact positions, and the center-of-mass position as the current position of the robot in the current environment.

17. The device according to claim 14, wherein the current motion parameter comprises an included angle of the joint of the robot; and the one or more processors are further configured to perform:
determining a relative position between a limb of the robot and a torso of the robot based on the included angle of the joint and sizes of limbs of the robot; and
determining a current posture of the robot based on the relative position between the limb and the torso of the robot.

18. The device according to claim 14, wherein the one or more processors are further configured to perform:
obtaining the target motion mode corresponding to the environment type;
obtaining a preconfigured initial motion parameter of the joint of the robot associated with the target motion mode;
performing iterative updating on the initial motion parameter of the joint based on the environment information corresponding to the environment type, to obtain a plurality of target motion parameters;
combining the plurality of target motion parameters based on chronological order of times at which the plurality of target motion parameters are generated, to obtain a parameter sequence, a target motion parameter in the parameter sequence being configured for controlling a motion state of the joint at a different time; and
controlling a motion state of the joint of the robot based on chronological order corresponding to the target motion parameter in the parameter sequence.

19. The device according to claim 18, wherein the one or more processors are further configured to perform:
invoking a neural network model to perform feature extraction based on the environment information corresponding to the environment type, to obtain an environment feature;
invoking a classifier of the neural network model to determine a type of the environment feature, to obtain a motion mode corresponding to the environment feature; and
using the motion mode corresponding to the environment feature as the target motion mode.

20. A non-transitory computer-readable storage medium containing a computer program that, when being executed, causes at least one processor to perform:
obtaining environment information of a current environment, in which the robot is located, and a current motion parameter of a joint of the robot;
determining an environment type of the current environment based on the environment information;
determining a current posture of the robot based on the current motion parameter of the joint;
determining position information of the robot in the current environment based on the environment information and the current motion parameter of the joint;
switching a current motion mode of the robot to a target motion mode corresponding to the environment type in response to the current posture and the position information satisfying a motion mode switching condition; and
configuring a target motion parameter for the joint of the robot based on the target motion mode corresponding to the environment type, the target motion parameter being configured for switching a part of the robot in contact with a ground to a ground contact part in the target motion mode.
